(19) United States
(12) Patent Application Publication
(10) Pub. No.: US 2020/0355021 A1
(43) Pub. Date: Nov. 12, 2020

(54) METHOD AND APPARATUS FOR REINFORCING SHEET METAL DOOR ASSEMBLIES

(71) Applicant: Southeast Cooler, Corp., Lithia Springs, GA (US)

(72) Inventors: Brian Lee Dallman, Temple, GA (US); Christopher David McCannon, Lithia Springs, GA (US)

(73) Assignee: Southeast Cooler, Corp., Lithia Springs, GA (US)

(21) Appl. No.: 16/866,207

(22) Filed: May 4, 2020

Related U.S. Application Data
(60) Provisional application No. 62/844,086, filed on May 6, 2019.

(51) Int. Cl. E06B 3/70

(52) U.S. Cl. CPC E06B 3/7015; E06B 2003/7023

(57) ABSTRACT

Apparatus and methods are used to reinforce doors on enclosures, including coolers, refrigerators and freezers. Each door, disposed over an opening in the enclosure, includes front, back and edge panels forming an interior space. A plurality of strengthening brackets, each having multiple panels at angles to one another, are positioned within the interior space of the door such that different bracket panels are adjacent respective inner surfaces of the door front, back and edge panels. A pair of door hinges configured to couple the door to a region around the opening in the enclosure, each include fasteners that extend through the edge panel of the door and one of the panels of a respective one of the strengthening brackets. The reinforcing brackets provide protection against forces applied to door panels associated with over-opening against an edge of the enclosure, and chains or cables exerting pulling forces on door panels.

### REFERENCE TO RELATED APPLICATIONS

This application claims the benefit of, and priority to, U.S. Provisional Patent Application Ser. No. 62/844,086, filed May 6, 2019, the entire content of which is incorporated herein by reference.

### FIELD OF THE INVENTION

This invention relates generally to enclosures, including coolers, freezers and refrigerators and, in particular, to apparatus and methods for reinforcing doors for these and other enclosures.

### BACKGROUND OF THE INVENTION

For several years, it has become economically advantageous to construct sheet metal door assemblies using foamed-in-place panels. Such foamed-in-place panels typically comprise sheet metal skins between which a two-part chemical foam insulation is injected and formed in situ. Despite the many advantages that foamed-in-place door construction has over other assemblies, such as, for example, using wood framed assemblies, using fiberglass insulation or wood framed assemblies, using foamed-in-place or PVC extrusion perimeters, and the like, is their lack of internal strength with respect to loads applied to the hinge and chain door or cable stop mount.

In particular, when foamed-in-place doors are opened and extended past 180 degrees at the hinge(s), the interior and/or exterior sheet metal skin is forced beyond its strength and bends, which affects how the door then seals when placed in the closed position.

Various methods have been employed by manufacturers to accomplish providing the added strength to doors manufactured in similar construction with metal interior and exterior skins. However, none of these techniques have been particularly successful.

### SUMMARY OF THE INVENTION

This invention relates generally to enclosures such as cooler, freezers and refrigerators and, in particular, to apparatus and methods for reinforcing doors for these and other enclosures. A door to which the invention is applicable is disposed over an opening in the enclosure, and comprises front, back and edge panels forming an interior space. In accordance with the invention, a strengthening bracket with multiple panels at angles to one another is positioned within the interior space such that different bracket panels are adjacent respective inner surfaces of the door front, back and edge panels. Door hardware is used to couple the door to one or more regions around the opening in the enclosure, and the door hardware uses a fastener that extends through one of the panels of the strengthening bracket and one of the door back or edge panels. The door hardware may be a door hinge or a door chain or cable.

Once the strengthening bracket is positioned, the interior space may be filled with a foam. The door front panel may be aluminum, and the door back panel may be steel. In the preferred embodiment, the different bracket panels are formed by bending a single piece of sheet metal, and the multiple panels of the strengthening bracket are at right angles to one another. The door front, back and edge panels are preferably constructed from sheet metal, and the door front panel may include a periphery that is bent to form the door edge panel. The bent door edge panel may be further bent to form a lip with an edge that is parallel to the front panel. The door back panel may include a peripheral edge that is spaced apart from the edge of the lip, with an elongated thermal expansion gasket that captures the edges of the lip and the door back panel. An elongated door seal may be attached to the elongated thermal expansion gasket. The strengthening bracket may include U-shaped portion configured to accommodate a portion of the elongated thermal expansion gasket.

The enclosure may be a refrigerated enclosure such as a cooler, refrigerator or freezer. Such an enclosure includes a cooled interior volume including an opening into the volume. At least one door disposed over the opening in the enclosure, includes front, back and edge panels forming a foam-filled interior space providing insulation. A plurality of strengthening brackets, each having multiple panels at angles to one another, are positioned within the interior space of the door such that different bracket panels are adjacent respective inner surfaces of the door front, back and edge panels. A pair of door hinges configured to couple the door to a region around the opening in the cooler, each include fasteners that extend through the edge panel of the door and one of the panels of a respective one of the strengthening brackets. The assembly may further including a chain or cable between the opening in the cooler and the door, and the chain or cable may be attached to the door with a fastener that extend through the back panel of the door and one of the panels of a strengthening bracket.

### BRIEF DESCRIPTION OF THE DRAWINGS

FIG. 1 is a perspective view of a reinforcing bracket constructed in accordance with the invention;

FIG. 2 is a perspective, exploded view of a door panel prior to final assembly showing possible placement of four reinforcing brackets;

FIG. 3 is a cross section of a portion of an assembled door showing a hinge connection;

FIG. 4 is a drawing that shows a cooler with two doors reinforced in accordance with the invention;

FIG. 5A illustrates a situation wherein an attempt is made to open a door reinforced in accordance with the invention past a side edge of a cooler, resulting in an impact at region; and

FIG. 5B depicts a situation wherein opening or over-opening a door reinforced in accordance with the invention causes tension in a chain, and how this pulling force is distributed throughout the bracket, also minimizing potential deformation.

It is to be noted that the drawing Figures presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing the several embodiments illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose. Additionally, in the Figures, like reference numerals and like description shall be used to designate corresponding elements, parts, and functionality throughout the several Figures.

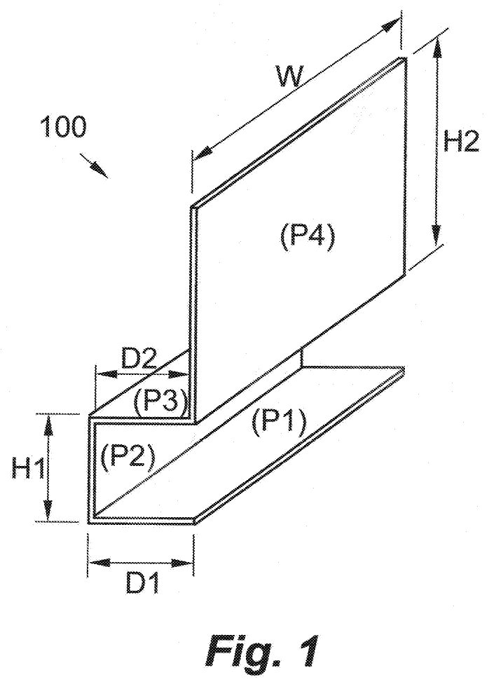

Turning now to the drawings, FIG. 1 is a perspective view of a reinforcing bracket constructed in accordance with the invention. The bracket 100 comprises a plurality of panels preferably formed by bending a single piece of sheet metal. Dimensions will be given for a particular cooler door construction, with the understanding that different dimensions may be used for different door geometries. Width W may be in the range of a few inches, such as 2 to 8 inches, most preferably 6 inches. D1, D2 and H1 are in the range of 1 to 1.5 inches, and H2 is about 2 inches, more or less. In a specific example found to be particularly effective through experimentation for a cooler door comprising two opposing foamed-in-place panels, the inside dimension of D1 and the outside dimension of D2 are 1.38 inches, the outside dimension of H1 is 1.25 inches, and H2 is 2.06 inches, enabling the bracket 100 to be formed from a 6″ by 6″ square blank of metal such as 16-gauge galvanized steel. The angles between the panels P1, P2, P3, P4 are preferably 90 degrees. Again, this is for a specific foamed-in-place cooler door having a height, width and thickness of about 43, 25, and 1.5 inches, respectively. Other values of D, H and P are possible for different door configurations.

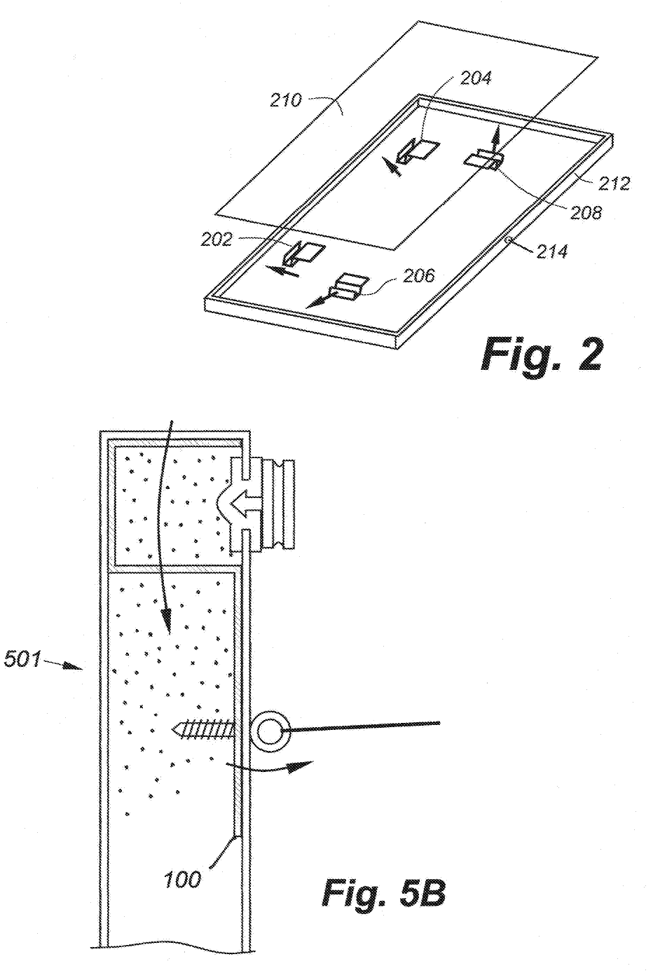

FIG. 2 is a perspective, exploded view of a door panel prior to final assembly showing possible placement of four of the brackets 100. Brackets 202, 204 are associated with strengthening hinge regions, whereas brackets 206, 208 may be used for strengthening areas where door-to-cooler chains are used. In practice, only one of the areas 206, 208 would be used for a chain on each door, but given that the doors are preferably reversible, two brackets 206, 208 are provided.

FIG. 2 also shows the outer door panel 212 and inner door panel 210. Outer panel 212 is preferably made from a single sheet of 0.040″ textured aluminum, with peripheral tabs that are bent to form the sides of the door. Inner panel 210 is preferably made from a single sheet of 24-gauge galvanized steel. The various brackets 202, 204, 206, 208 are taped, glued or otherwise positioned against the inside surface of the outer door panel 212, and the two panels are assembled using a peripheral thermal breaker strip shown in subsequent figures. The joined panels are then placed in a fixture and foam such as expanding polyurethane foam is injected into the interior space between the panels through latch hole 214.

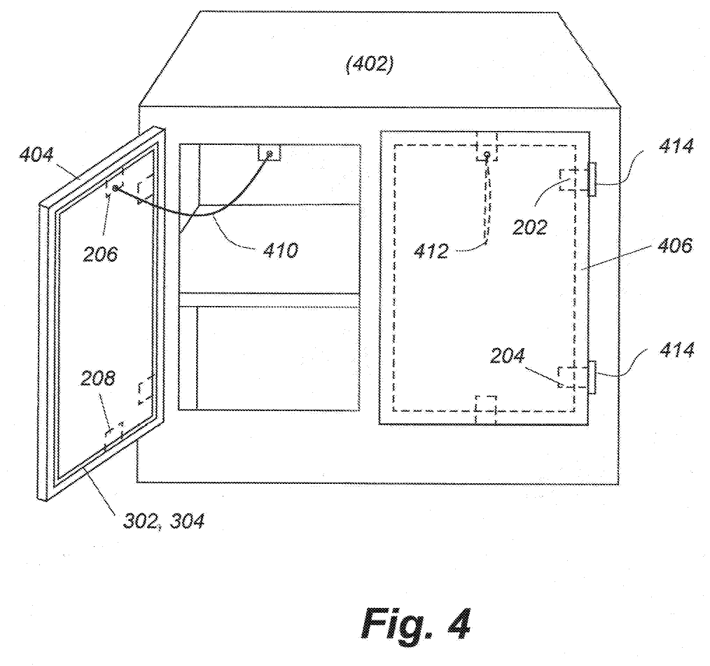

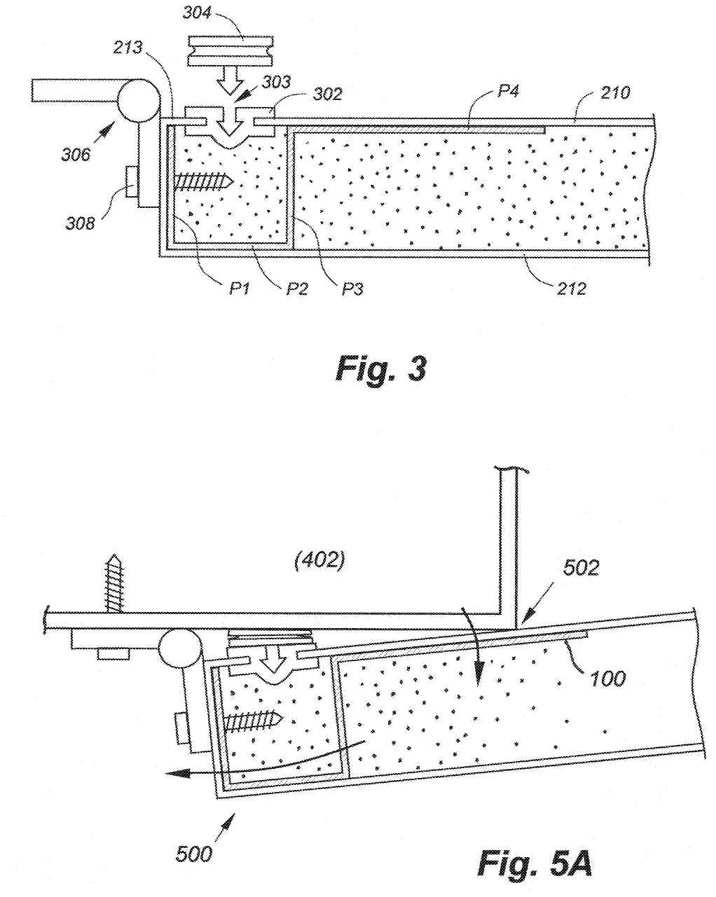

FIG. 3 is a cross section of a portion of an assembled door showing a hinge connection. The edge of inner panel 210 and bent lip 213 of outer panel 212 fit into a thermal breaker strip 302. Strip 302 serves several purposes, including panel assembly while defeating the formation of condensation on the outer surface of the outer door when inner panel 210 is cooled. Strip 302 also maintains a separation between the dissimilar metals used to form the two panels. The strip 302 includes an elongated groove 303 configured to receive a peripheral seal 304, which may be magnetic.

Hinge 306 is fastened to the side of the door through P1 of the bracket 100. Note that the space between panels P1 and P3 allows room for both the strip 302 and the fastener(s) 308. Note further that panels P1, P2 and P4 all make intimate contact with door panel surfaces. In particular, the outer surface of panel P1 contacts the inner surface of the door side panel; the outer surface of P2 contacts the inner surface of outer door panel 212, and the outer surface of P4 contacts the inner surface of inner door panel 210.

FIG. 4 is a drawing that shows a refrigerated enclosure 402 that may be a cooler, refrigerator or freezer, including two doors 404, 406 reinforced in accordance with the invention. Door 404 is open, showing a chain 410 collecting the cooler to an area of door 404 reinforced with internal bracket 206. Bracket 208 is not used on the left door but is used on right door 406 in conjunction with chain 412. Right door 406 shows how the areas associated with the attachment of hinges 414, 416 are strengthened with brackets 202, 204.

It has been discovered through experimentation that the particular bracket structure and positioning described herein provides unexpected strength with respect to forces experienced during use. FIG. 5A illustrates a situation wherein an attempt is made to open door 500 past a side edge of enclosure 402, resulting in an impact when the door is in a full open position as indicated by the arrow around region 502. In this case the applied force is distributed by bracket 100, thereby dramatically limiting deformation compared to doors without the brackets. The bracket 100 effectively ‘binds’ the transfer force in several areas transferring and sharing the force through region 500. Similarly, as shown in FIG. 5B, when opening or over-opening door 501 to an extent that causes tension in chain 503, again, using the same strengthening bracket structure, this pulling force is distributed throughout the bracket, also minimizing potential deformation.

Having thus described exemplary embodiments of the subject matter of the present disclosure, it is noted that the within disclosures are exemplary only and that various other alternatives, adaptations, and modifications may be made within the scope and spirit of the present invention. Accordingly, the present subject matter is not limited to the specific embodiments as illustrated herein, but is limited only by the following claims.

1. A reinforced door disposed over an opening in an enclosure, comprising:
a door back panel having an inner surface and an outer surface;
a door front panel having an inner surface and an outer surface, the door front panel being spaced apart from the door back panel;
a door edge panel surrounding the door front and back panels, the door edge panel having an inner surface and an outer surface;
wherein the door front, back and edge panels form an interior space;
a strengthening bracket having multiple panels at angles to one another, the strengthening bracket being positioned within the interior space such that different bracket panels are adjacent respective inner surfaces of the door front, back and edge panels; and
door hardware adapted to couple the door to a region around the opening in the enclosure, the door hardware including a fastener that extends through one of the panels of the strengthening bracket and one of the door back or edge panels.

2. The reinforced door of claim 1 wherein, once the strengthening bracket is positioned, the interior space is filled with a foam.

3. The reinforced door of claim 1, wherein the different bracket panels are formed by bending a single piece of sheet metal.

4. The reinforced door of claim 1, wherein the multiple panels of the strengthening bracket are at right angles to one another.

5. The reinforced door of claim 1, wherein the door front, back and edge panels are constructed from sheet metal.

6. The reinforced door of claim 1, wherein the door front panel includes a periphery that is bent to form the door edge panel.

7. The reinforced door of claim 6, wherein:
the bent door edge panel is further bent to form a lip that is parallel to the front panel, and the lip includes an edge.

8. The reinforced door of claim 7, wherein:
the door back panel includes a peripheral edge that is spaced apart from the edge of the lip; and
further including an elongated thermal expansion gasket that captures the edges of the lip and the door back panel.

9. The reinforced door of claim 8, further including an elongated door seal attached to the elongated thermal expansion gasket.

10. The reinforced door of claim 8, wherein the door front panel is aluminum and the door back panel is steel.

11. The reinforced door of claim 8, wherein:
the strengthening bracket includes U-shaped portion in cross section; and
the U-shaped portion receives a portion of the elongated thermal expansion gasket.

12. The reinforced door of claim 1, wherein the door hardware is a door hinge.

13. The reinforced door of claim 1, wherein the door hardware is a door chain.

14. The reinforced door of claim 1, wherein the enclosure is a cooler, refrigerator or freezer.

15. A refrigerated enclosure, comprising:
a cooled interior volume including an opening into the volume;
at least one door disposed over the opening in the enclosure, the including front, back and edge panels forming a foam-filled interior space;
a plurality of strengthening brackets, each bracket having multiple panels at angles to one another, and wherein the strengthening brackets are positioned within the interior space of the door such that different bracket panels are adjacent respective inner surfaces of the door front, back and edge panels; and
a pair of door hinges configured to couple the door to a region around the opening in the enclosure, each hinge including fasteners that extend through the edge panel of the door and one of the panels of a respective one of the strengthening brackets.

16. The refrigerated enclosure of claim 15, further including a chain between the opening in the cooler and the door; and
the chain is attached to the door with a fastener that extend through the back panel of the door and one of the panels of a strengthening bracket.

17. The refrigerated enclosure of claim 15, wherein the door panels and strengthening brackets are formed from sheet metal.
